(19) United States
(12) Patent Application Publication
(10) Pub. No.: US 2023/0275330 A1
(43) Pub. Date: Aug. 31, 2023

(54) Secondary Battery And Method For Manufacturing The Same

(71) Applicant: LG Energy Solution, Ltd., Seoul (KR)

(72) Inventors: Gi Man Kim, Daejeon (KR); Dae Hong Kim, Daejeon (KR); Kyoung Won Kang, Daejeon (KR); Hyung Ho Kwon, Daejeon (KR)

(73) Assignee: LG Energy Solution, Ltd., Seoul (KR)

(21) Appl. No.: 18/018,200

(22) PCT Filed: Sep. 10, 2021
(86) PCT No.: PCT/KR2021/012356

§ 371 Date: Jan. 26, 2023

(30) Foreign Application Priority Data
Sep. 11, 2020 (KR) 10-2020-0117212
Sep. 8, 2021 (KR) 10-2021-0120034

(51) Int. Cl. H01M 50/54; H01M 50/105; H01M 50/178; H01M 10/04

(52) U.S. Cl. CPC H01M 50/54; H01M 50/105; H01M 50/178; H01M 10/049

(57) ABSTRACT

A secondary battery comprises: an electrode assembly having electrodes, a separator interposed between the electrodes, and electrode tabs; an electrode lead coupled to the electrode tabs; and a pouch configured to accommodate the electrode assembly therein, wherein the electrode tabs comprise a connection part connected to the electrodes, a coupling part coupled to the electrode lead in a state of being combined into a mass, and a bent part provided between the connection part and the coupling part, and the bent part comprises a first bent surface connected to the coupling part and bent at a first-b angle, a second bent surface connected to the connection part and bent at a second-b angle, and a connection surface configured to connect the first bent surface to the second bent surface, wherein the first-b angle is greater than the second-b angle.

### TECHNICAL FIELD

### Cross-Reference to Related Application

The present application claims the benefit of the priority of Korean Patent Application Nos. 10-2020-0117212, filed on Sep. 11, 2020, and 10-2021-0120034, filed on Sep. 8, 2021, which are hereby incorporated by reference in their entirety.

### TECHNICAL FIELD

The present invention relates to a secondary battery and a method for manufacturing the same, and more particularly, to a secondary battery, in which a margin (i.e., an extra length) at which a length of an electrode tab is capable of increasing is secured, and a method for manufacturing the same.

### BACKGROUND ART

In general, secondary batteries refer to chargeable and dischargeable, unlike primary batteries that are not chargeable. The secondary batteries are being widely used for mobile phones, notebook computers, and camcorders, electric vehicles, and the like.

Such a secondary battery is classified into a can type secondary battery in which an electrode assembly is built in a metal can and a pouch type secondary battery in which an electrode assembly is built in a pouch. In addition, the pouch type secondary battery comprises an electrode assembly having a structure, in which electrodes and separators are alternately stacked, an electrode lead coupled to an electrode tab of the electrode assembly, and a pouch accommodating the electrode assembly in a state in which a front end of the electrode lead is withdrawn to the outside.

However, in the secondary battery according to the related art, when a swelling phenomenon occurs in the electrode assembly, there is a problem in that the electrode tab connected between the electrode assembly and the electrode lead is stretched to cause disconnection.

In order to solve this problem, the secondary battery according to the related art significantly secures a length between the electrode and the electrode lead to increase in length of the electrode tab, thereby preventing the electrode tab from being disconnected. However, when the electrode tab increases in length as described above, there is a problem in that a size of the secondary battery unnecessarily increases.

### DISCLOSURE OF THE INVENTION

### Technical Problem

In a secondary battery and a method for manufacturing the same according to the present invention for solving the above problem, a margin, at which a length of the electrode tab is capable of increasing, so that even if swelling occurs in the electrode assembly, the length of the electrode tab increases to prevent the electrode tab from being disconnected and prevent the secondary battery from increasing in length.

### Technical Solution

A secondary battery according to the present invention for achieving the above object comprises: an electrode assembly provided with a plurality of electrodes, a separator interposed between the plurality of electrodes, and a plurality of electrode tabs respectively connected to the plurality of electrodes; an electrode lead coupled to the plurality of electrode tabs; and a pouch configured to accommodate the electrode assembly in a state in which a front end of the electrode lead is withdrawn to the outside, wherein the plurality of electrode tabs comprise a connection part connected to the plurality of electrodes, a coupling part coupled to the electrode lead in a state of being combined into a mass, and a bent part provided between the connection part and the coupling part, and the bent part comprises a first bent surface connected to the coupling part and bent at a first-b angle, a second bent surface connected to the connection part and bent at a second-b angle, and a connection surface configured to connect the first bent surface to the second bent surface, wherein the first-b angle is greater than the second-b angle.

The first-b angle of the first bent surface may be 100° to 120° with respect to the coupling part.

The first-b angle of the first bent surface may be 109° to 116° with respect to the coupling part.

The second-b angle of the second bent surface may be 94° to 104° with respect to the connection part.

The second-b angle of the second bent surface may be 98° to 100° with respect to the connection part.

When viewed in a longitudinal direction of the electrode assembly, a distance (α) from one end to the other end of the connection surface to which each of the first bent surface and the second bent surface is connected may be 0.5 mm to 2.0 mm.

When viewed in a longitudinal direction of the electrode assembly, a distance (β) from an end of the separator to an end of the coupling part, which face each other, may be 2.0 mm to 4.5 mm.

A method for manufacturing a secondary battery according to the present invention comprises: a process (a) of preparing a plurality of electrodes provided with electrode tabs and alternately disposing a plurality of electrodes and a plurality of separators to manufacture an electrode assembly; a process (b) of bending the plurality of electrode tabs to be combined, wherein the bent electrode tab is provided with a connection part connected to each of the electrodes, a coupling part which is combined into a mass and to which an electrode lead is coupled, and a bent part provided between the connection part and the coupling part, and the bent part is provided with a first bent surface coupled to the coupling part and bent at a first-a angle, a second bent surface connected to the connection part and bent at a second-a angle, and a connection surface connecting the first bent surface to the second bent surface; a process (c) of coupling the electrode lead to the coupling part of the electrode tab; a process (d) of accommodating the electrode assembly in a pouch in a state in which a front end of the electrode lead is withdrawn to the outside and then attaching an electrode film to the electrode lead disposed on the sealing part of the pouch; a process (e), in which, when the lead film is pushed by a first length into the pouch, the electrode lead is inserted by the first length into the pouch by the lead film, the first-a angle of the first bent surface is adjusted to be reduced to a first-b angle while pushing the bent part by the electrode lead, and the second-a angle of the second bent surface is adjusted to be reduced to a second-b angle; and a process (f) of sealing a sealing part (310) of the pouch on which the lead film is disposed, wherein the first-b angle is greater than the second-b angle.

In the process (e), the first-b angle of the first bent surface may be 100° to 120° with respect to the coupling part.

In the process (e), wherein the second-b angle of the second bent surface may be 94° to 104° with respect to the connection part.

In the process (d), when the lead film is attached to the electrode lead, the lead film may be attached to be withdrawn further by the first length to the outside of the pouch, and in the process (e), the lead film may be pushed by the first length into the pouch, wherein the first length may be 0.5 mm to 1.5 mm.

In the process (e), when viewed in a longitudinal direction of the electrode assembly, a distance (a) from one end to the other end of the connection surface to which each of the first bent surface and the second bent surface may be connected is 0.5 mm to 2.0 mm.

When the process (e) is completed, a distance (β) between an end of the separator and an end of the coupling part, which face each other, may be 2.0 mm to 4.5 mm.

A process of inspecting whether the first-b angle of the first bent surface and the second-b angle of the second bent surface are within a preset angle range may be further performed between the process (e) and the process (f).

in the process (e1), when viewed in a longitudinal direction of the electrode assembly, a distance (a) from one end to the other end of the connection surface to which each of the first bent surface and the second bent surface may be connected is 0.5 mm to 2.0 mm.

### Advantageous Effects

The secondary battery according to the present invention may comprise the electrode tab provided with the bent part, and the bent part may comprise the first bent surface connected to the coupling part and bent at the first-b angle, the second bent surface connected to the connection part and bent at the second-b angle, and the connection surface connecting the first bent surface to the second bent surface. The first-b angle may have the angle greater than the second-b angle. Due to such the feature, the electrode tab may secure the margin (i.e., the extra length) that is capable of increasing in length. That is, when the swelling occurs in the electrode assembly, the bent part of the electrode tab may be unfolded to increase in length, thereby preventing the disconnection of the electrode tab from occurring. Particularly, it is possible to prevent the secondary battery from increasing in size, thereby improving the productivity.

In addition, in the secondary battery of the present invention, the first and second bent surfaces may be provided as the curved surfaces. Due to such the feature, it is possible to prevent the first and second bent surfaces from being folded.

### BRIEF DESCRIPTION OF THE DRAWINGS

FIG. 1 is a cross-sectional view of a secondary battery according to a first embodiment of the present invention.

FIG. 2 is a partially enlarged view of FIG. 1.

FIG. 3 is a side view illustrating an electrode tab of the secondary battery according to the first embodiment of the present invention.

FIG. 4 is a cross-sectional view illustrating a state in which an electrode assembly of the secondary battery is deformed according to the first embodiment of the present invention.

FIG. 5 is a flowchart illustrating a method for manufacturing a second battery according to a second embodiment of the present invention.

FIG. 6 is a cross-sectional view illustrating a process (a) in the method for manufacturing the second battery according to the second embodiment of the present invention.

FIG. 7 is a cross-sectional view illustrating a process (b) in the method for manufacturing the second battery according to the second embodiment of the present invention.

FIG. 8 is a side view of an electrode tab that is bent in the process (b).

FIG. 9 is a cross-sectional view illustrating processes (b) and (d) in the method for manufacturing the second battery according to the second embodiment of the present invention.

FIG. 10 is a cross-sectional view illustrating a process (e) in the method for manufacturing the second battery according to the second embodiment of the present invention.

FIG. 11 is a side view of an electrode tab that is deformed in the process (e).

FIG. 12 is a cross-sectional view illustrating a process (f) in the method for manufacturing the second battery according to the second embodiment of the present invention.

FIGS. 13 to 16 are photographed images illustrating an experimental example of the present invention.

### MODE FOR CARRYING OUT THE INVENTION

Hereinafter, embodiments of the present invention will be described in detail with reference to the accompanying drawings in such a manner that the technical idea of the present invention may easily be carried out by a person with ordinary skill in the art to which the invention pertains. The present invention may, however, be embodied in different forms and should not be construed as limited to the embodiments set forth herein. In the drawings, anything unnecessary for describing the present invention will be omitted for clarity, and also like reference numerals in the drawings denote like elements.

[Secondary Battery According to First Embodiment of the Present Invention]

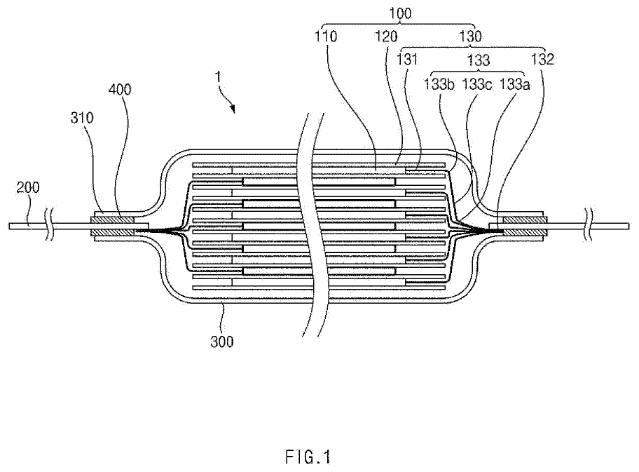

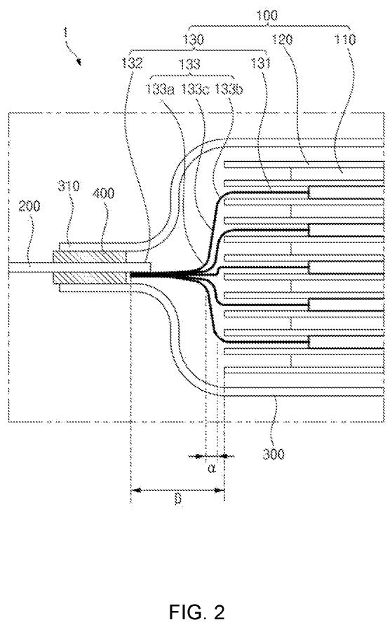

As illustrated in FIGS. 1 to 4, a secondary battery 1 according to a first embodiment of the present invention comprises an electrode assembly 100 provided with a plurality of electrode tabs, an electrode lead 200 coupled to the plurality of electrode tabs, a pouch 300 accommodating the electrode assembly 100 in a state in which a front end of the electrode lead 200 is withdrawn to the outside, and an electrode film 400 provided on the electrode lead 200 disposed on an sealing part 310 of the pouch 300.

Electrode Assembly

The electrode assembly 100 comprises a plurality of electrodes 110, a separator 120 disposed between the plurality of electrodes 110, and a plurality of electrode tabs 130 respectively connected to the plurality of electrodes 110.

Here, the plurality of electrodes 110 may be a positive electrode and a negative electrode, and the plurality of electrode tabs 130 may be a positive electrode tab connected to the positive electrode and a negative electrode tab connected to the negative electrode.

The electrode assembly 100 having such a configuration has a structure in which the plurality of electrodes 110 are stacked vertically with the separator 120 therebetween. In this case, the plurality of electrode tabs 130 are connected to the plurality of electrodes 110 in the same direction. For example, the plurality of positive electrode tabs are arranged to face a left direction when viewed in FIG. 1, and the plurality of negative electrode tabs are arranged to face a right direction as viewed in FIG. 1.

The plurality of electrode tabs 130 comprise a connection part 131 connected to each of the plurality of electrodes 110 and a coupling part 132 that is welded in a state of being combined into a single mass and is coupled to the electrode lead 200.

Electrode Lead

The electrode lead 200 is configured to connect the electrode assembly to an external device and is coupled to the coupling part 132 of the electrode tab 130.

Pouch

The pouch 300 is configured to accommodate the electrode assembly in a state in which the front end of the electrode lead 200 is withdrawn to the outside. That is, the pouch 300 comprises an accommodating part accommodating the electrode assembly 100 and a sealing part 310 sealing the accommodating part.

The pouch 300 further comprises a lead film 400 for improving sealing force between the sealing part 310 and the electrode lead 200.

Lead Film

The lead film 400 has a structure surrounding an outer circumferential surface of the electrode lead 200 disposed on the sealing part 310. That is, the lead film 400 may be bonded to the sealing part 310 when the sealing part 310 is thermally fused to improve the sealing force between the electrode lead and the sealing part.

The secondary battery 1 according to the first embodiment of the present invention has a structure, in which even if the electrode assembly is swelled to increase in thickness or length, disconnection of the electrode tab 130 is prevented.

That is, in the secondary battery 1 according to the first embodiment of the present invention, the electrode tab 130 may be provided in a bent state to secure a margin. Thus, when the electrode assembly 100 is swelled, the bent electrode tab 130 may be unfolded to be flat, and thus, the length of the electrode tab 130 may increase to prevent the electrode tab 130 from being disconnected.

For example, the plurality of electrode tabs 130 further comprise a bent part 133 provided between the connection part 131 and the coupling part 132.

The bent part 133 comprises a first bent surface 133a connected to the coupling part 132 and bent at a first-b angle 1b° along a thickness direction (approximately ‘└’ shape) of the electrode assembly 100, a second bent surface 133b connected to the connection part 131 and bent at a second-b angle 2b° along a direction (approximately ‘┐’ shape) parallel to a longitudinal direction of the electrode assembly 100, and a connection surface 133c connecting the first bent surface 133a to the second bent surface 133b.

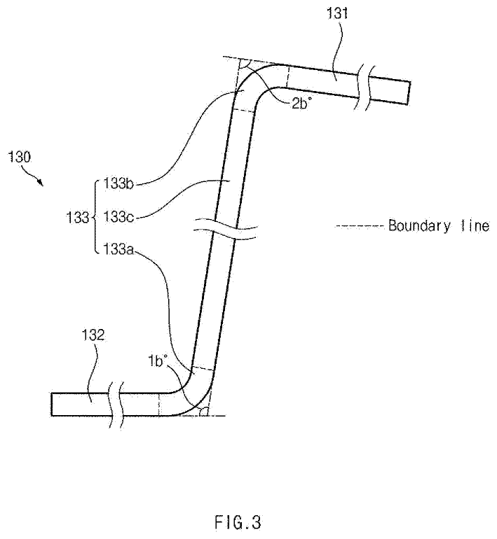

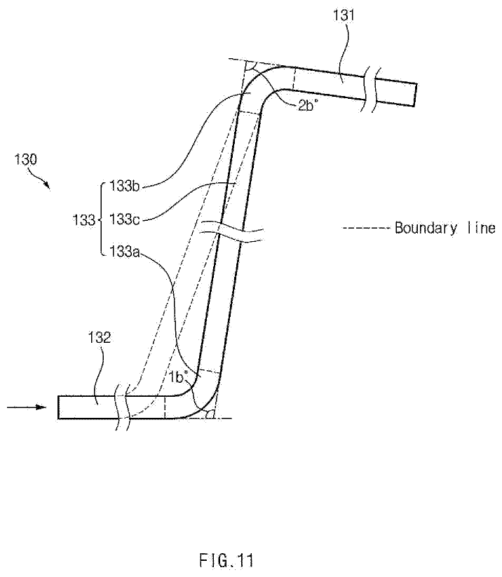

As illustrated in FIGS. 3, 8, and 11, a boundary line (---) is drawn to distinguish positions of the first bent surface 133a, the second bent surface 133b, and the connecting surface 133c from each other.

Here, the first-b angle 1b° is greater than 90° when viewed with respect to the connection part 131. Thus, even when the electrode tab is pressed, the bent part 133 may be induced to be folded in a direction in which the bent part 133 does not face the electrode assembly, and as a result, the electrode may be prevented from being in contact with an electrode having a polarity different from that of the electrode tab.

In addition, the second-b angle 2b° is greater than 90° when viewed with respect to the coupling part 132. Thus, even when the electrode tab 130 is compressed in the thickness direction of the electrode assembly, the bent part 133 may be prevented from being folded in a direction in which the bent part 133 faces the electrode assembly, thereby preventing the electrode tab from being in contact with an electrode having a different polarity.

The first-b angle 1b° may be greater than the second-b angle 2b°. That is, the second-b angle 2b° is formed to be less than the first-b angle 1b° to minimize the space between the electrode tab and the electrode assembly, and the first-b angle 1b° is formed to be greater than the second-b angle 2b° to allow the electrode lead and the electrode assembly to be largely spaced apart from each other. In addition, the first-b angle 1b° may be formed to be greater than the second-b angle 2b° to significantly secure a margin between the electrode tab and the pouch.

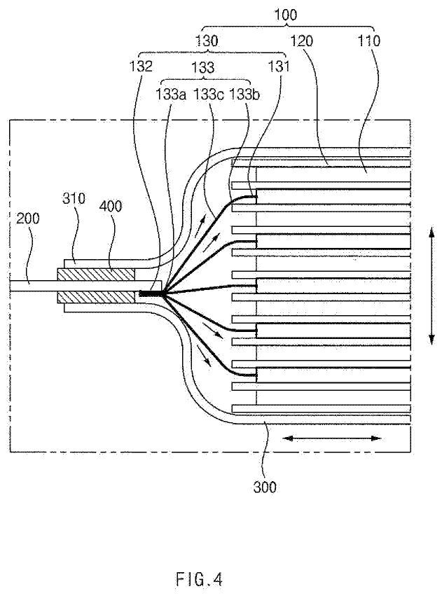

Referring to FIG. 4, in the plurality of electrode tabs 130 having such the structure, when the electrode assembly 100 is swelled, a thickness or length of the electrode assembly 100 may increase, and thus, the first and second bent surfaces 133a and 133b of the bent part 133 may be unfolded to prevent the electrode tab 130 from being disconnected. That is, since the electrode tab 130 has the bent shape, the margin may be secured to prevent the electrode tab 130 from being disconnected.

Particularly, each of the plurality of electrode tabs 130 may be made of a metal material having restoring force, and thus, when the electrode assembly 100 returns to its original shape, the bent part 133 may also return to its original shape, and as a result, efficiency in reuse may be improved.

Therefore, since the electrode assembly 100 comprises the electrode tab 130 having the secured margin, even if the electrode assembly is swelled, the disconnection of the electrode tab 130 may be prevented to improve the safety.

The first bent surface 133a or the second bent surface 133b is formed as a bent surface. Thus, it is possible to prevent the first and second bent surfaces 133b from being folded at a right angle due to an external impact. Particularly, when the swelling occurs in the electrode assembly 100, the electrode assembly 100 may be unfolded more quickly to significantly prevent the electrode tab 130 from being disconnected.

A distance β between an end of the separator and an end of the coupling part 132, which face each other, in the electrode assembly 100 is 2.0 mm to 4.5 mm, preferably 3.5 mm. That is, when the electrode tab 130 is bent, the distance β between the end of the separator 120 and the end of the coupling part 132 is close to 2.0 mm to 4.5 mm. Thus, the secondary battery may be designed to be more compact in side. Here, when the distance between the end of the separator 120 and the end of the coupling part 132 is 2.0 mm or less, the electrode tab 130 may be in contact with the electrode having the different polarity or the electrode lead 200 having the different polarity to cause short circuit. When the distance between the end of the separator 120 and the end of the coupling part 132 is 4.5 mm or more, the secondary battery may unnecessarily increase in size.

When viewed in the longitudinal direction of the electrode assembly 100, a distance α from one end to the other end of the connection surface 133c to which each of the first bent surface 133a and the second bent surface 133b is connected is 0.5 mm to 2.0 mm, preferably 1.0 mm. Accordingly, the length of the secondary battery may be minimized, and also, the margin of the electrode tab 130 may be stably secured. Here, if the distance α from one end to the other end of the connection surface 133c is 0.5 mm or less, there is a problem in that the electrode tab 130 and the electrode assembly 100 are in contact with each other, and if the distance a is 2.0 mm or more, there is a problem in that the secondary battery largely increases in length to deteriorate a product quality.

Referring to FIG. 3, the first-b angle 1b° of the first bent surface 133a is inclined to be bent at 100° to 120°, preferable 109° to 116° in the thickness direction of the electrode assembly 100 with respect to the coupling part 132, and the second-b angle 2b° of the second bent surface 133b is inclined to be bent at 94° to 104°, preferably 98° to 100° with respect to the connection part 131. Thus, since each of the first and second bent surfaces 133a and 133b is inclined at the predetermined angle, the bent part 133 may maximally secure the margin of the electrode tab 130 without damaging the pouch or separator.

Therefore, since the secondary battery 1 according to the first embodiment of the present invention comprises the electrode tab 130 having the first and second bent surfaces, the electrode tab 130 may be prevented from being disconnected to improve the safety.

Hereinafter, a method for manufacturing the secondary battery according to the second embodiment of the present invention will be described.

[Method for Manufacturing Secondary Battery According to Second Embodiment of the Present Invention]

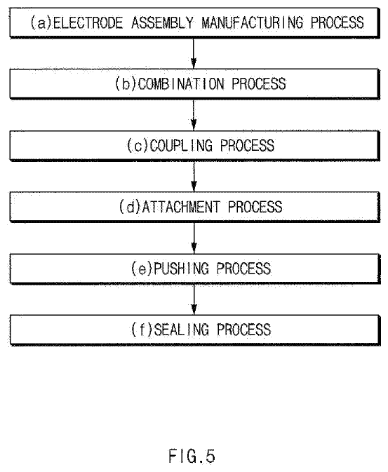

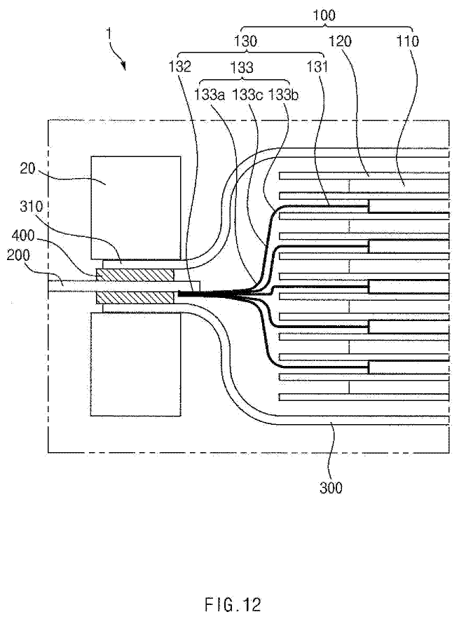

As illustrated in FIGS. 5 to 12, a method for manufacturing a secondary battery according to a second embodiment of the present invention comprises an electrode assembly manufacturing process (a), a combination process (b), a coupling process (c), an attachment process (d), a pushing process (e), and a sealing process (f).

(a) Electrode Assembly Manufacturing Process

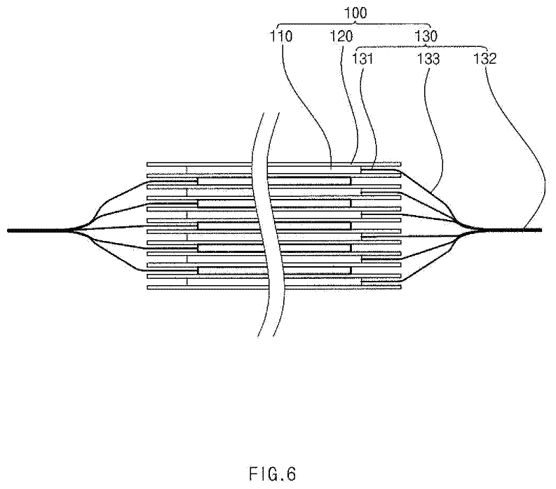

In the process (a), as illustrated in FIG. 6, an electrode 110 provided with an electrode tab 130 is provided in plurality. Next, a plurality of electrodes 110 and a plurality of separators 120 are alternately disposed to manufacture an electrode assembly 100. Here, the electrode tabs 130 provided on the plurality of electrodes 110 are disposed to face the same direction.

(b) Combination Process

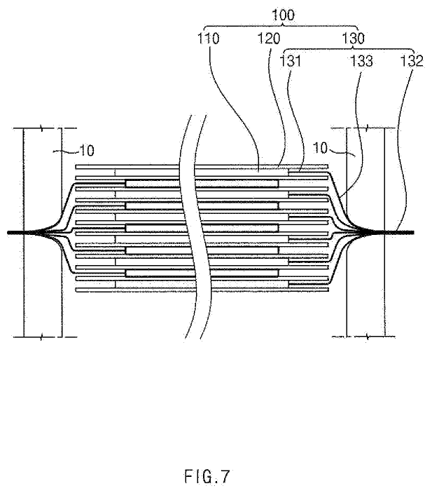

In the process (b), as illustrated in FIG. 7, sides of the plurality of electrode tabs 130 are compressed using a pair of compression blocks 10 to combine front ends of the electrode tabs 130 into a single mass.

Here, the sides of the plurality of electrode tabs are bent at a first-a angle 1a° in a thickness direction of the electrode assembly 100 to form a first bent surface 133a, and other ends are bent at a second-a angle 2a° in the thickness of the electrode assembly 100 to form a second bent surface 133b. Here, a connection surface 133c is formed between the first bent surface 133a and the second bent surface 133b.

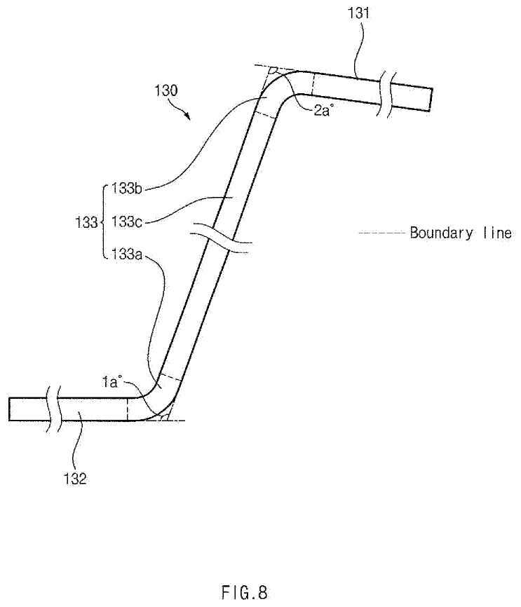

In summary, as illustrated in FIG. 8, the electrode tab 130 comprises a connection part 131 connected to an electrode, a coupling part 132 combined into a mass and coupled to an electrode lead 200, and a bent part 133 provided between the connection part 131 and the coupling part 132. Also, the bent part 133 comprises a first bent surface 133a connected to the coupling part 132 and bent at the first-a angle 1a°, a second bent surface 133b connected to the connection part 131 and bent at the second-a angle 2a°, and a connection surface 133c connecting the first bent surface 133a to the second bent surface 133b.

Here, edges of the pair of compression blocks 10 are formed as curved surface, and thus, the first bent surface 133a compressed by the pair of compression blocks 10 is formed as a curved surface.

The first-a angle 1a° of the first bent surface 133a is inclined to be bent at 130° to 150°, preferable 148° in the thickness direction of the electrode assembly 100 with respect to the coupling part 132, and the second-a angle 2a° of the second bent surface 133b is inclined to be bent at 94° to 104°, preferably 99° with respect to the connection part 131.

(c) Coupling Process

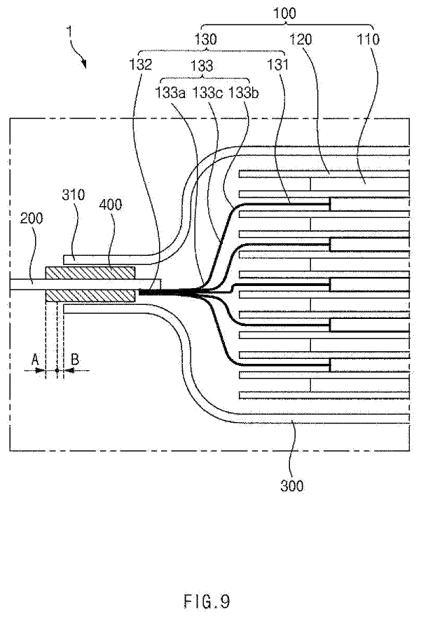

In the process (c), as illustrated in FIG. 9, the front ends of the electrode tabs 130 combined into the single mass are welded to form the coupling part 132, and the electrode lead 200 is coupled to the coupling part 132.

After the process (c), when viewed in a longitudinal direction of the electrode assembly, a distance α from one end to the other end of the connection surface 133c to which each of the first bent surface 133a and the second bent surface 133b is connected is 2.0 mm to 3.0 mm, preferably 2.0 mm. That is, the distance a from one end to the other end of the connection surface 133c is secured so that the bent part 133 is pressed.

(d) Attachment Process

In the process (d), the electrode assembly is accommodated in a pouch 300 in a state in which a front end of the electrode lead 200 is withdrawn to the outside, and then, an electrode film 400 is attached to the electrode lead 200 disposed on a sealing part 310 of the pouch 300. Here, the lead film 400 is attached to be withdrawn further by a first length B to the outside of the sealing part 310 of the pouch 300.

That is, referring to FIG. 9, the lead film 400 is withdrawn by a length A to the outside of the sealing part 310, and in the present application, the lead film 400 is withdrawn further by the first length B to the outside of the sealing part of the pouch 300.

Here, the first length B may be 1 mm to 2 mm, preferably 1 mm.

(e) Pushing Process

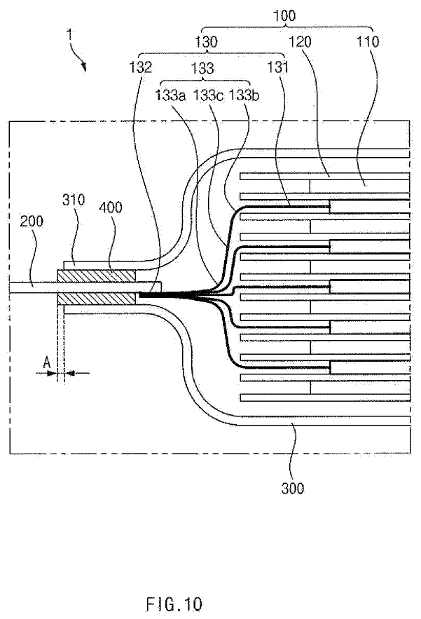

In the process (e), as illustrated in FIG. 10, the lead film 400 is pushed to be inserted by the first length B into the pouch 300 with respect to the sealing part 310 of the pouch 300. Thus, the electrode lead 200 is inserted by the first length B into the pouch 300 by the lead film 400, and the bent part 133 is deformed while being pressed by the electrode lead 200 in a direction of the electrode assembly 100. Here, a first-a angle of the first bent surface 133a is adjusted to be reduced to a first-b angle, and a second-a angle of the second bent surface 133b is adjusted to be reduced to a second-b angle. Here, the first-b angle of the first bent surface 133a is connected to the coupling part that is combined into the single mass so as to be largely adjusted in angle, and the second-b angle of the second bent surface 133b is connected to the plurality of connection parts so as to be adjusted small in angle or so as not to be adjusted in angle. Thus, since the first-b angle is largely changed compared to the first-a angle, the first-b angle is greater than the second-b angle.

Here, the lead film 400 and the sealing part 310 are separated from each other without being sealed.

Here, the first-b angle 1b° of the first bent surface 133a is inclined to be bent at 100° to 120°, preferably 109° to 116° in the thickness direction of the electrode assembly 100 with respect to the coupling part 132 and also inclined to be optimally bent at 111°. The second-b angle 2b° of the second bent surface 133b is 94° to 104°, preferably 98° to 100°, and optimally, 99° with respect to the connection part 131.

After the process (e), a distance between an end of the separator 120 and an end of the coupling part 132, which face each other, is 2.0 mm to 4.5 mm, preferably 3.5 mm.

That is, before the process (e), the distance between the end of the separator 120 and the end of the coupling part 132, which face each other, is 4.5 mm, and after the process (e), the distance between the end of the separator 120 and the end of the coupling part 132 is 3.5 mm.

In addition, after the process (e), when viewed in the longitudinal direction of the electrode assembly, the distance from one end of the bent surface, to which the first bent surface is connected, to the other end of the bent surface, to which the second bent surface 133b is connected, is 0.5 mm to 2.0 mm, preferably 1.0 mm. Thus, a length of the secondary battery in the longitudinal direction may be minimized, and as a result, the secondary battery may increase in size.

(f) Sealing Process

In the process (f), the sealing part 310 of the pouch 300 is sealed using a sealing block 20. Thus, the electrode assembly 100 is accommodated in the pouch 300 so as to be sealed.

When the above processes are completed, a finished secondary battery 1 may be manufactured.

A process of inspecting whether the first-b angle of the first bent surface 133a and the second-b angle of the second bent surface 133b are within a preset angle range is further performed between the process (e) and the process (f).

(e1) Inspection Process

In the process (e1), the secondary battery 1 is vision-photographed, an image of the electrode assembly is output from the photographed image, the first-b angle of the first bent surface 133a and the second-b angle of the second bent surface 133b are measured from the photographed output image of the electrode assembly, and the first-b angle of the first bent surface 133a and the second-b angle of the second bent surface 133b, which are measured, are compared to the preset angle to inspect whether detects occur.

Here, the preset angle range of the first angle is 109° to 116°, and the preset angle range of the second angle is 94° to 104°.

Thus, in the process (e1), the bending state of the electrode tab 130 may be inspected.

In the process (e1), when viewed in a longitudinal direction of the electrode assembly, whether a distance α from one end to the other end of the connection surface 133c to which each of the first bent surface 133a and the second bent surface 133b is connected is 0.5 mm to 2.0 mm, preferably 2.0 mm is further inspected.

Therefore, in a method for manufacturing the secondary battery according to the second embodiment of the present invention, a secondary battery 1 having a secured margin may be manufactured.

[Experimental Example]

In the method for manufacturing the secondary battery according to the second embodiment of the present application, four secondary batteries manufactured up to the attachment process (d) are prepared. The four secondary batteries have the same structure and are referred to as first to fourth experimental pieces.

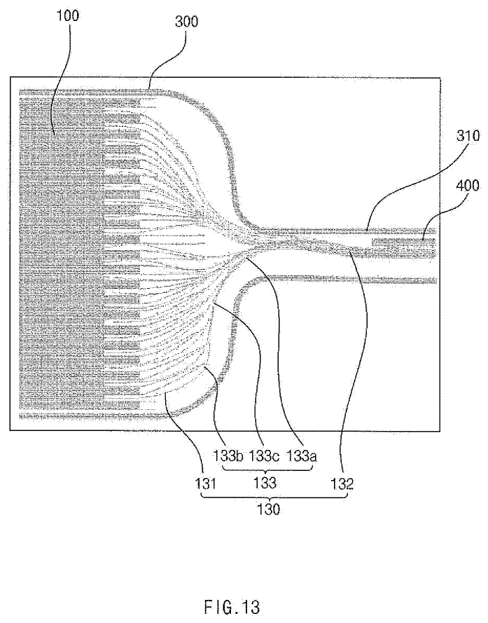

In Experimental Example 1, the first experimental piece before the pushing process (e) is photographed. As a result, a photographic image as illustrated in FIG. 13 may be obtained.

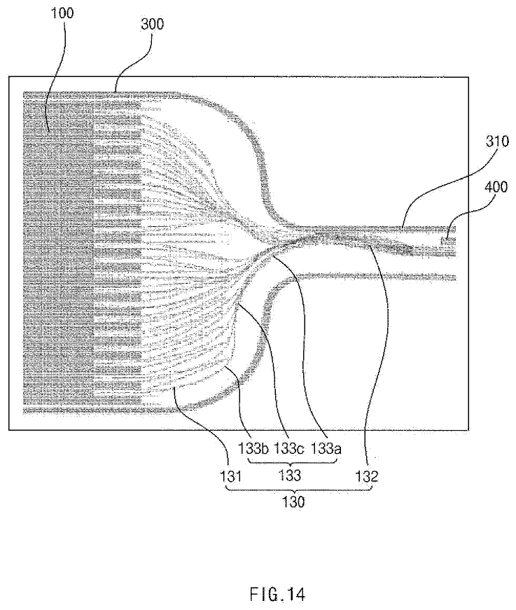

In Experimental Example 2, an electrode lead 400 of the second experimental piece is pushed by 0.5 mm in the pushing process (e), and then, the second experimental piece is photographed. As a result, a photographic image as illustrated in FIG. 14 may be obtained. That is, it is confirmed that the bent angle of the electrode tab 130 is changed in the second experimental piece rather than in the first experimental piece, and a phenomenon in which a gap occurs between the electrode and the separator does not occur.

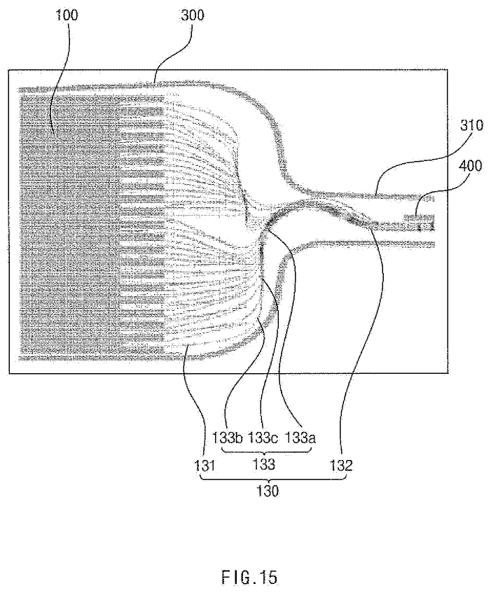

In Experimental Example 3, an electrode lead 400 of the third experimental piece is pushed by 1.0 mm in the pushing process (e), and then, the third experimental piece is photographed. As a result, a photographic image as illustrated in FIG. 15 may be obtained. That is, it is confirmed that the bent angle of the electrode tab 130 is changed in the third experimental piece rather than in the second experimental piece, and a phenomenon, in which a gap between the electrode and the separator is widened, does not occur.

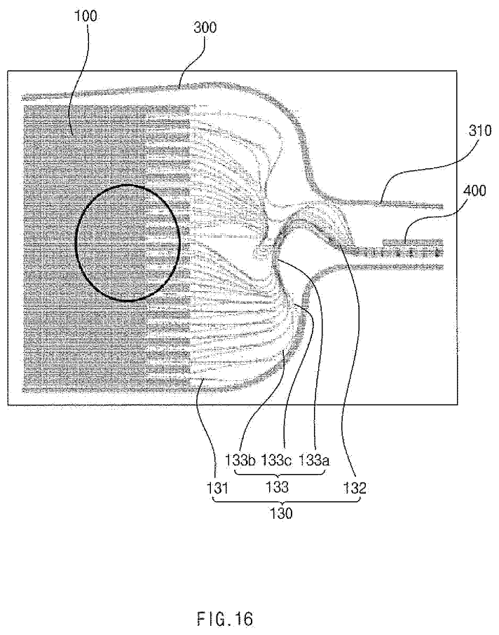

In Experimental Example 4, an electrode lead 400 of the fourth experimental piece is pushed by 1.2 mm in the pushing process (e), and then, the fourth experimental piece is photographed. As a result, a photographic image as illustrated in FIG. 16 may be obtained. That is, it is seen that the bending angle of the electrode tab 130 is significantly changed in the fourth experimental piece rather than in the third experimental piece. However, it is seen that defects, in which a gap between the electrode and the separator is widened, occur.

Therefore, as the results of the above experiments, in order to prevent the defects from occurring in the pushing process (e), the lead film 400 has to be pushed by 0.5 mm to 1.5 mm, preferably by 1.0 mm, and when the pushing excesses the above-described values, defects, in which the gap between the electrode and the separator is widened, occur.

Accordingly, the scope of the present invention is defined by the appended claims more than the foregoing description and the exemplary embodiments described therein. Various modifications made within the meaning of an equivalent of the claims of the invention and within the claims are to be regarded to be in the scope of the present invention.

### DESCRIPTION OF THE SYMBOLS

1: Secondary battery
100: Electrode assembly
110: Electrode
120: Separator
130: Electrode tab
131: Connection part
132: Coupling part
133: Bent part
133a: First bent surface
133b: Second bent surface
133c: Connection surface
200: Electrode lead
300: Pouch
400: Lead film

1. A secondary battery comprising:
an electrode assembly having a plurality of electrodes, a plurality of separators respectively interposed between the plurality of electrodes, and a plurality of electrode tabs respectively connected to the plurality of electrodes;
an electrode lead coupled to the plurality of electrode tabs; and
a pouch accommodating the electrode assembly therein in a state in which a front end of the electrode lead extends through the pouch to an outside of the pouch,
wherein the plurality of electrode tabs each comprise a connection part connected to a respective one of the plurality of electrodes, a coupling part coupled to the electrode lead, and a bent part extending between the connection part and the coupling part, and the bent part of each of the plurality of electrode tabs comprises a first bent surface connected to the respective coupling part and bent at a first-b angle, a second bent surface connected to the respective connection part and bent at a second-b angle, and a connection surface extending between the first bent surface to the second bent surface, and
wherein the first-b angle is greater than the second-b angle.

2. The secondary battery of claim 1, wherein the first-b angle of the first bent surface of each of the plurality of electrode tabs is 100° to 120° with respect to the respective coupling part.

3. The secondary battery of claim 2, wherein the first-b angle of the first bent surface of each of the plurality of electrode tabs is 109° to 116° with respect to the respective coupling part.

4. The secondary battery of claim 1, wherein the second-b angle of the second bent surface of each of the plurality of electrode tabs is 94° to 104° with respect to the respective connection part.

5. The secondary battery of claim 4, wherein the second-b angle of the second bent surface of each of the plurality of electrode tabs is 98° to 100° with respect to the respective connection part.

6. The secondary battery of claim 1, wherein, when viewed in a longitudinal direction of the electrode assembly, a distance (α) from a first end to a second end of the connection surface of each of the plurality of electrode tabs is 0.5 mm to 2.0 mm.

7. The secondary battery of claim 1, wherein, for each of the plurality of electrode tabs, when viewed in a longitudinal direction of the electrode assembly, a distance (β) from an end of a respective one of the separators to an end of the respective coupling part is 2.0 mm to 4.5 mm, the end of the respective one of the separators and the end of the respective coupling part facing each other.

8. A method for manufacturing a secondary battery, the method comprising:
preparing a plurality of electrodes each having an electrode tab and alternately disposing the plurality of electrodes and a plurality of separators to manufacture an electrode assembly;
bending the electrode tabs, so that each electrode tab has a connection part connected to a respective one of the plurality of electrodes, a coupling part to which an electrode lead is coupled, and a bent part extending between the connection part and the coupling part, and the bent part of each electrode tab has a first bent surface coupled to the respective coupling part and bent at a first-a angle, a second bent surface connected to the respective connection part and bent at a second-a angle, and a connection surface connecting the first bent surface to the second bent surface;
coupling the electrode lead to the coupling part of each of the electrode tab;
accommodating the electrode assembly in a pouch in a state in which a front end of the electrode lead extends through the pouch to an outside of the pouch and then attaching a lead film to the electrode lead disposed on a sealing part of the pouch;
pushing the lead film by a first length into the pouch, thereby inserting the electrode lead into the pouch by the first length, such that the first-a angle of the first bent surface is reduced to a first-b angle, and the second-a angle of the second bent surface is reduced to a second-b angle; and
sealing a sealing part of the pouch on which the lead film is disposed,
wherein the first-b angle is greater than the second-b angle.

9. The method of claim 8, wherein the first-b angle of the first bent surface of each electrode tab is 100° to 120° with respect to the respective coupling part.

10. The method of claim 8, wherein the second-b angle of the second bent surface of each electrode tab is 94° to 104° with respect to the respective connection part.

11. The method of claim 8, wherein the first length is 0.5 mm to 1.5 mm.

12. The method of claim 8, wherein, after the pushing of the lead film, when viewed in a longitudinal direction of the electrode assembly, a distance (α) from a first end to a second end of the connection surface of each of the electrode tabs is 0.5 mm to 2.0 mm.

13. The method of claim 8, wherein, after the pushing of the lead film, for each of the electrode tabs, a distance (β) between an end of a respective one of the separators and an end of the respective coupling part is 2.0 mm to 4.5 mm, the end of the respective one of the separators and the end of the respective coupling part facing each other.

14. The method of claim 8, further comprising, between the pushing of the lad film and the sealing of the sealing part, inspecting whether the first-b angle of the first bent surface and the second-b angle of the second bent surface of each of the electrode tabs are within a predetermined angle range.

15. (canceled)
